(19) United States
(12) Patent Application Publication
(10) Pub. No.: US 2011/0110723 A1
(43) Pub. Date: May 12, 2011

(54) GREEN SYNTHESIS OF NANOMETALS USING FRUIT EXTRACTS AND USE THEREOF

(75) Inventors: Rajender S. Varma, Cincinnati, OH (US); Babita Baruwati, Cincinnati, OH (US); George E. Hoag, Bloomfield, CT (US); John B. Collins, Bloomfield, CT (US)

(73) Assignee: VeruTEK Technologies, Inc., Bloomfield, CT (US)

(21) Appl. No.: 12/893,826

(22) Filed: Sep. 29, 2010

Related U.S. Application Data
(60) Provisional application No. 61/246,953, filed on Sep. 29, 2009.

(51) Int. Cl. B09C 1/08; B22F 9/18; B32B 5/16; B82Y 40/00; B82Y 99/00

(52) U.S. Cl. 405/128.75; 75/371; 75/373; 428/402; 977/773; 977/840; 977/903

(57) ABSTRACT

The present invention relates to methods of making and using and compositions of metal nanoparticles formed by green chemistry synthetic techniques. For example, the present invention relates to metal nanoparticles formed with solutions of fruit extracts and use of these metal nanoparticles in removing contaminants from soil and groundwater and other contaminated sites.

This application claims the benefit of U.S. Provisional Application No. 61/246,953, filed Sep. 29, 2009.

Certain aspects of this invention were made with the support of the Government of the United States of America, and the Government has certain rights in the invention.

The present invention relates to methods of making and using and compositions of metal nanoparticles formed by green chemistry synthetic techniques. For example, the present invention relates to metal nanoparticles formed with solutions of fruit extracts and use of these metal nanoparticles in removing contaminants from soil and groundwater and other contaminated sites.

### BACKGROUND

Nanoparticles are particles ranging in size from 1 nm to 1 micron in diameter. “Nano” is a prefix which means a one-billionth (101 part of something. In recent years, the field of nanoparticles has grown due to their unique properties. Many industries utilize nanoparticles, for example the electronics industry, medical science, material science, and environmental science. Noble metal nanoparticles have found widespread use in several technological applications and various wet chemical methods have been reported. See, X. Wang and Y. Li, Chem. Commun., 2007, 2901; Y. Sun and Y. Xia, Science, 2002, 298, 2176; J. Chen, J. M. McLellan, A. Siekkinen, Y. Xiong, Z-Y Li and Y. Xia, J. Am. Chem. Soc., 2006, 128, 14776; J. W. Stone, P. N. Sisco, E. C. Goldsmith, S. C. Baxter and C. J. Murphy, NanoLett., 2007, 7, 116; B. Wiley, Y. Sun and Y. Xia, Acc. Chem. Res., 2007, 40, 1067. Metal nanoparticles can have unique properties and potential applications. The optical,^{[1]} electronic,^{[2]} magnetic,^{[3]} and catalytic^{[4]} properties of metal nanoparticles depends on their morphology and size distribution. Noble metal nano particles can have interesting properties because of their close lying conduction and valence bands in which electrons move freely. These free electrons generate surface plasmon bands that depend on the particle's size, shape, and surroundings. Similarly, the color of noble metal nanoparticles depends on both the size and shape of the particles as well as the refractive index of the surrounding medium.

Metal and semiconductor nanoparticles can have properties that differ from those of the corresponding bulk material. An example of a nanoparticle is nanoscale zero valent iron (nZVI). Generally, nanoparticles are synthesized in three ways: physically by crushing larger particles, chemically by precipitation, and through gas condensation. Chemical generation is highly varied and can incorporate laser pyrolysis, flame synthesis, combustion, and sol gel approaches. See, U.S. Pat. No. 6,881,490 (2005-04-19) N. Kambe, Y. D. Blum, B. Chaloner-Gill, S. Chiruvolu, S. Kumar, D. B. MacQueen. Polymer-inorganic particle composites; J. Du, B. Han, Z. Liu and Y. Liu, Cryst. Growth and Design, 2007, 7, 900; B. Wiley, T. Herricks, Y. Sun and Y. Xia, Nano Lett., 2004, 4, 2057; C. J. Murphy, A. M. Gole, S. E. Hunyadi and C. J. Orendorff, Inorg. Chem., 2006, 45, 7544; B. J. Wiley, Y. Chen, J. M. McLellan, Y. Xiong, Z-Y. Li, D. Ginger, and Y. Xia, Nanoletters, 2007, 4, 1032; Y. Xiong, H. Cai, B. J. Wiley, J. Wang, M. J. Kim and Y. Xia, J. Am. Chem. Soc., 2007, 129, 3665; J. Fang, H. You, P. Kong, Y. Yi., X. Song, and B. Ding, Cryst. Growth and Design, 2007, 7, 864; A. Narayan, L. Landstrom and M. Boman, Appl. Surf. Sci., 2003, 137, 208; H. Song, R. M. Rioux, J. D. Hoefelmeyer, R. Komor, K. Niesz, M. Grass, P. Yang and G. A. Somorjai, J. Am. Chem. Soc., 2006, 128, 3027; C. C. Wang, D. H. Chen and T. C. Huang, Colloids Surf, A 2001, 189, 145. Examples of mechanical processes for producing nanoparticles include mechanical attrition (e.g., ball milling), crushing of sponge iron powder, and thermal quenching. Examples of chemical processes for producing nanoparticles include precipitation techniques, sol-gel processes, and inverse-micelle methods. Other chemical or chemically-related processes include gas condensation methods, evaporation techniques, gas anti-solvent recrystallization techniques, precipitation with a compressed fluid anti-solvent, and generation of particles from gas saturated solutions. The commercial significance of nanoparticles is limited by the nanoparticle synthesis process, which is generally energy intensive or requires toxic chemical solvents and is costly.

### SUMMARY

A method according to the present invention for making one or more metal nanoparticles includes providing a solution comprising a metal ion, providing a fruit extract, for example, a non-citrus fruit extract, that includes compound such as a reducing agent, a capping agent, a stabilizing agent, a solvent, a vitamin, a sugar, an amino acid, a peptide, a polyphenol, an alcohol, an anthocyanin, or a combination, and combining the metal ion solution and the fruit extract to produce metal nanoparticles. If the fruit extract is from a citrus fruit, the fruit extract can include a compound such as a reducing agent, a capping agent, a peptide, a polyphenol, an alcohol, an anthocyanin, or a combination. The fruit extract can be, for example, a juice or pulp fruit extract.

The metal ion solution and the fruit extract can be combined at room temperature to produce the metal nanoparticles, or the metal ion solution and the fruit extract can be heated, for example, by microwave radiation, to produce the metal nanoparticles. The fruit extract can include a solvent, a reducing agent, and a stabilizing or capping agent. For example, the fruit extract can include a solvent, a reducing agent, a stabilizing agent, and a polyphenolic. The fruit extract can be grape pomace or red wine. For example, the metal ion can be a noble metal, a base metal, or another metal. For example, the metal ion can be selected from the group consisting of gold (Au), platinum (Pt), silver (Ag), palladium (Pd), copper (Cu), iron (Fe), indium (In), and manganese (Mn). The concentration of the metal ion in the solution can be in the range of from about 0.1 mM to about 1000 mM, from about 1 mM to about 100 mM, or can be about 10 mM. The dissolved metal ion can be provided by a species including, for example, a metal salt, an iron salt, ferric chloride (FeCl₃), ferrous sulfate (FeSO₄), ferric nitrate (Fe(NO₃)₃), a manganese salt, manganese chloride (MnCl₂), manganese sulfate (MnSO₄), a silver salt, silver nitrate (AgNO₃), a palladium salt, palladium chloride (PdCl₂), a metal chelate, Fe(III)-EDTA, Fe(III)-citric acid, Fe(III)-EDDS, Fe(II)-EDTA, Fe(II)-citric acid, Fe(II)-EDDS, and combinations thereof.

An embodiment of the invention includes one or more metal nanoparticles prepared according to a method of the invention. The metal nanoparticles can have a mean diameter in the range of from about 1 to about 300 nm, a mean diameter in the range of from about 5 to about 50 nm, a mean diameter in the range of from about 10 to about 30 nm, a mean diameter in the range of from about 2 to about 20 nm, or a mean diameter of about 10 nm. The metal nanoparticles can be substantially non-aggregated.

An embodiment of the invention includes an iron nanoparticle having a surface and a compound such as an amino acid, a peptide, an anthocyanin, a polyphenol, a phenolic compound, gallic acid, a catechin, a quercetin, tartaric acid, malic acid, succinic acid, resveratrol, or a combination of two or more of these. The compound can be coated on the surface of the iron nanoparticle.

A method according to the invention can include screening waste streams from fruit processing to identify a fruit extract that comprises polyphenols. A method according to the invention can include administering the metal nanoparticles to a pollutant to substantially destroy the pollutant, for example, a pollutant including an organic compound. A method according to the invention can include injecting the metal nanoparticles into the ground to treat a contaminated soil. For example, a method for reducing the concentration of a contaminant in a medium according to the invention can include introducing a fruit extract that includes a compound such as a reducing agent, a capping agent, an amino acid, a peptide, a polyphenol, an alcohol, an anthocyanin, or a combination into the medium. The compound(s) of the fruit extract can be allowed to react with metal ions in the medium to form metal nanoparticles. The metal nanoparticles can be allowed to reduce or stimulate biological reduction of the contaminant to reduce its concentration. For example, a chelating agent, for example, of EDTA, citric acid, EDDS, or a combination can be administered to the medium.

### DESCRIPTION OF THE DRAWINGS

FIG. 1 presents (a) a TEM micrograph and (b) a UV-Visible spectrum of Au nanoparticles synthesized using red wine at 50 watt microwave power and 60 second exposure time.

FIG. 2 presents X-ray diffraction patterns of as-synthesized metal nanoparticles using pomace extract.

FIG. 3 presents a TEM micrograph of Au nanoparticles synthesized using white wine at 50 watt microwave power and 60 second exposure time.

FIG. 4 presents a TEM micrograph of Au nanoparticles synthesized using pomace at 50 watt microwave power and 60 second exposure time.

FIG. 5 presents a TEM micrograph of Au nanoparticles particles synthesized using wine pomace at room temperature, 3 hours reaction time.

FIG. 6 presents a TEM micrograph of Au nanoparticles synthesized using red wine at room temperature: (a) 3 hours; and (b) 48 hours.

FIG. 7 presents a TEM micrograph of (a) Ag, (b) Pd, and (c) Pt nanoparticles synthesized using wine pomace at 50 watt microwave power and 60 second exposure time.

FIG. 8 presents a graph illustrating plant extract DPPH stable radical consumption from nanoscale zero valent iron particle formation from reaction of green tea extract with ferric chloride.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention. All references cited herein are incorporated by reference as if each had been individually incorporated. U.S. provisional patent application No. 61/071,785 (filed May 16, 2008) and international patent application number PCT/US2009/044402 (filed May 18, 2009) are hereby incorporated by reference in their entirety.

As used herein, “nano-sized” and “nano-scale” mean particles less than about 1 micron in diameter, though a different meaning may be apparent from the context. As used herein, “micro-sized” and “micro-scale” mean particles from about 1 to about 1000 microns in diameter. As used herein, “macro-sized” and “macro-scale” mean particles greater than about 1000 microns in diameter. A “nanoparticle” is a particle whose diameter falls within the nano-scale range. A nanoparticle can be zero-valent, or it can carry a charge.

As used herein, “fruit extract” includes any substance derived from a fruit. For example, fruit extract can include juice, pulp, skin, and or seed of a fruit. The fruit extract can be obtained from the fruit by any process, for example, pressing, mashing, peeling, exposure to sound or ultrasound, for example, high intensity sound or ultrasound, cold water extraction, hot water extraction, extraction with solvent, and/or extraction with a supercritical solvent. Extraction with a solvent can include, for example, extraction with a plant based solvent such as a citrus terpene, a pine extract, or another plant extract, such as a plant extract capable of extracting polyphenols, for example, from particulate matter of a fruit. Fruit extract includes a substance separated from the fruit without being further processed, such as juice pressed from a fruit, and can include a substance separated from the fruit, which then is further processed by physical, chemical, or biochemical means. For example, fermented fruit juice, such as wine, is encompassed by the term fruit extract.

As used herein, “contaminant” encompasses any substance present in a location that, by its presence, diminishes the usefulness of the location for productive activity or natural resources, or would diminish such usefulness if present in greater amounts or if left in the location for a length of time. The location may be subsurface, on land, in or under the sea or in the air. As used herein, “contaminated soil” encompasses any soil that contains at least one contaminant according to the present invention. “Contaminant” thus can encompass trace amounts or quantities of such a substance. Examples of productive activities include, without limitation, recreation, residential use, industrial use, habitation by animal, plant, or other life form, including humans, and similar such activities. Examples of natural resources include aquifers, wetlands, sediments, soils, plant life, animal life, and ambient air quality.

Compounds useful for producing metal nanoparticles can include polyphenols, antioxidants, radical scavengers, polyphenolic flavonoids, flavinoid phenolic compounds, flavinoids, flavonoids, flavonols, flavones, flavanones, isoflavones, flavans, flavanols, anthocyanins, proanthocyanins, carotenoids, catechins, quercetins, rutins, catechins, epicatechins and their esters from ferulic and gallic acids, e.g. epigallocatechin Antioxidant compounds that can be useful for metal nanoparticle synthesis include natural antioxidants such as flavonoids, e.g., quercetin, glabridin, red clover, and Isoflavin Beta (a mixture of isoflavones available from Campinas of Sao Paulo, Brazil). Other examples of natural antioxidants that can be used as antioxidants for synthesizing metal nanoparticles include beta carotene, ascorbic acid (vitamin C), vitamin B1, vitamin B2, tocopherol (vitamin E) and their isomers and derivatives. Non-naturally occurring antioxidants, such as beta hydroxy toluene (BHT) and beta hydroxy anisole (BHA), can also be used to synthesize metal nanoparticles. Without intending to be bound by theory, polyphenols, such as epi-catechins and epi-catechin gallates, may play an important role in the reduction of metal salts to form metal nanoparticles, for example, iron nanoparticles. Different plants and different parts of plants contain various antioxidants in varying proportions which can serve as reducing agents.

Methods of producing nanoparticles with a range of sizes and shapes can use toxic chemicals and solvents, so that environmental safety is an issue. The present invention includes green and sustainable pathways that reduce or eliminate waste generation, use environmentally friendly solvents, and/or use environmentally friendly reducing agents. Factors in the preparation of nanoparticles that can be evaluated from a green chemistry perspective include the following examples: the choice of the solvent medium, the selection of an environmentally benign reducing agent, and the use of a nontoxic material for the stabilization of the nanoparticles.^{[5]} Some reports have been presented.^{[6-11]} In an embodiment of the present invention a single, environmentally friendly source (e.g., grape pomace) is used as a solvent, reducing agent, and stabilizing agent for the production of metal nanoparticles.

Several approaches for the generation of nanoparticles using water, vitamins, plant extracts, sugars, and peptides, etc., have been presented.^{[12-16]} Sugars^{[13]} and polyphenolics from tea and coffee^{[17]} extracts can be used to produce nanoparticles. Wine, which includes alcohol, sugar, anthocyanins, and polyphenols, can be used to produce nanoparticles. The present invention includes a green synthetic method for generating metal nanoparticles, such as gold (Au), silver (Ag), palladium (Pd), platinum (Pt), and iron (Fe) nanoparticles. Red wine and/or grape pomace extract can serve as a green (environmentally friendly), single (that is, a three-in-one) source of solvent, reducing agent, and stabilizing (or capping) agent for the production of metal nanoparticles. Red grape pomace includes polyphenolic compounds that can act as capping agents and reducing agents during the synthesis of metal nanoparticles. Microwave irradiation can be used to produce highly crystalline nanoparticles from a metal ion solution with fruit extract within a few seconds.

In an embodiment, a series of tests can be conducted for the purpose of optimizing the nanoparticles produced for an application. For example, the concentration of one or more metal ions in solution, the concentration of one or more compounds of interest, such as a polyphenol, in a fruit extract, the ratios of such concentrations, and/or the temperature can be varied when combining the metal ion solution and the fruit extract to produce metal nanoparticles. Examples of parameters of the nanoparticles that can be optimized include the number (for example, per mole of metal ion molecules in solution) of nanoparticles produced, as well as the size, size distribution, shape, and shape distribution of nanoparticles produced. For example, the stability, aggregation, and size and shape of aggregates of nanoparticles can be optimized. The nanoparticles can be optimized to have physical, chemical, and/or biological properties suited for an application. For example, the nanoparticles can be optimized to have a diameter sufficient small for the particles to have a high surface area to volume ratio, but at the same time persist in a system of interest for a sufficiently long period of time without dissolving.

Using red wine as the single source of reducing agent, capping agent, and solvent, high quality nanocrystals of noble metals were produced. In contrast, the particles tended to be agglomerated when white wine was used, presumably because of the lack of polyphenolics to cap the particles. Pomace is the major waste product of wine manufacture and has a high concentration of polyphenolics. Pomace was used as a three-in-one agent (reducing agent, capping agent, and solvent) for nanoparticle synthesis in a method according to the present invention.

In a method according to the invention, the fruit extract can be combined with a substance other than a metal ion solution or in addition to a metal ion solution. Such a process can be used to produce, for example, biopolymer nanoparticles.

In a method according to the invention, waste streams from fruit processing can be screened to assess their utility for the production of nanoparticles. For example, the concentration of polyphenols in a waste stream can be determined. Some applicable methods include the DPPH method (see Example 7) and an oxygen radical absorbance capacity (ORAC) method, which can use trolox (6-hydroxy-2,5,7,8-tetramethylchroman-2-carboxylic acid) as a standard. Additional examples of methods used to determine the concentration of a compound such as a polyphenol in a waste stream include HPLC (high performance liquid chromatography) and/or HPLC (ultra high performance liquid chromatography), which can be applied in combination with techniques such as mass spectroscopy, a photodiode array, such as in a diode array detector, UV-Vis detection, a fluorescence technique, and/or another analytic technique. The screening of a waste stream can be performed prior to mixing of the waste stream with another waste stream or process stream, and can be performed prior to separation of components of the waste stream, for example, through concentration of solids from a liquid waste stream, such as through filtration, reverse osmosis, and/or evaporation. Components separated from a waste stream can be screened, for example, to determine the concentration of polyphenols.

In addition to screening waste streams from a fruit processing operation, damaged fruit crops that cannot be used for their originally intended agricultural purpose can be screened, for example, to determine the concentration of polyphenols, for use in producing nanoparticles, for example, in an embodiment according to the present invention. For example, fruit crops that have been damaged by spoiling, weather (e.g., hail or excessive rain), insects, bacterial infection, viral infection, and/or fungal infection can be screened.

Furthermore, in addition to screening waste streams from a fruit processing operation, damaged fruit crops, and other quantities of fruit that may ordinarily be disposed of, fruit that is not damaged or considered waste can be screened, for example, to determine the concentration of polyphenols. For example, such undamaged fruit could include fruit for which the economic value for the production of nanoparticles by an embodiment of the present invention is higher than the economic value when used as food or used to produce food products. For example, undamaged fruit with a high concentration of polyphenols may be screened.

The green synthesized nanoparticles and compositions including these nanoparticles according to embodiments of the invention can be used, for example, to remediate contaminated sites by inducing chemical reduction mechanisms, by stimulating biological reduction mechanisms, or by a combination of chemical and biological reduction mechanisms. For example, the green synthesized nanoparticles, including zero valent nanometal particles and bimetallic particles, can serve as reducing agents in processes to detoxify inorganic species, such as metals, heavy metals, arsenical compounds, and chromium compounds, e.g., Hg²⁺, Ni²⁺, Ag⁺, Cd²⁺, Cr₂O₇²⁻, and AsO₄³⁻, by in-place manufacture and treatment. The green synthesized nanoparticles, e.g., zero valent nanometal particles, can be used as reducing agents to destroy oxidizing agent compounds such as perchlorates (ClO₄⁻) and nitrates (NO₃⁻). The metal nanoparticles can be administered with, for example, plant derived reducing agents, in order to increase the reducing effect of the nanoparticles on the species to be remediated.

The nanoparticles and compositions including them can be used for catalysis, for example, to activate free radical oxidation chemistries for remediation, water treatment, and wastewater treatment. Green synthesized nanoparticles, such as nZVI or nZVMn particles, and compositions including them can be applied to remediate sites contaminated with, for example, non-aqueous phase liquids (NAPLs), dense non-aqueous phase liquids (DNAPLs), and/or light non-aqueous phase liquids (LNAPLs). The green synthesized nanoparticles can be applied together with VeruTEK's VeruSOL green co-solvents and surfactants and/or oxidants. For example, the metal nanoparticles can be applied with a natural solvent or surfactant, such as, for example, VeruSOL-3, Citrus Burst 1 (CB-I), Citrus Burst 2 (CB-2), Citrus Burst 3 (CB-3), EZ-Mulse, or combinations thereof, For example, the metal nanoparticles can be applied with a chelating agent, such as, for example, EDTA (ethylene diamine tetraacetic acid), EDDS (ethylenediaminedissuccinate), citric acid, TAML, EDDHA, EDDHMA, EDDCHA, EDDHSA, NTA, DTPA, or combinations thereof. For example, the metal nanoparticles can be applied with oxidants such as peroxide (e.g., calcium peroxide, hydrogen peroxide), air, oxygen, ozone, persulfate (e.g., sodium persulfate), percarbonate, and permanganate. The green synthesized nanoparticles can be used, for example, to remediate contaminated water, wastewater, building materials and equipment, and subsurfaces. nZVI can be produced with fruit extract and ferric chloride in the presence or absence of VeruSOL-3. Similarly, nZVI can be produced with fruit extract and chelated iron in the presence or absence of VeruSOL-3. Iron nanoparticles can be produced with combining an iron salt, such as iron nitrate, with a fruit extract, such as red grape pomace.

Nanoparticles, such as single metal, bimetallic, and multimetallic nanoparticles according to the invention can be used, for example, as catalysts and/or activators. For example, such nanoparticles can be used as catalysts and activators to form oxidative and reductive free radicals. For example, such nanoparticles can be used to form radicals from chemical oxidants, such as liquid and solid phase persulfates, liquid and solid phase peroxides, liquid and solid phase percarbonates, liquid and solid phase perborates, and perchlorates. For example, such nanoparticles can be used to form radicals from aliphatic, aromatic, and polyaromatic hydrocarbons.

The nanoparticles according to the invention and compositions including them can be applied in conjunction with, for example, catalyzed oxidant systems or reduction technologies to destroy immiscible organic liquids, such as dense non-aqueous phase liquids (DNAPL) and/or light non-aqueous phase liquids (LNAPL) compounds. Thus, nanoparticles according to the invention and compositions including them can be used, for example, to treat CERCLA Sites, NPDES permitted discharges, and RCRA Sites. Furthermore, systems regulated under the Safe Drinking Water Act, Clean Water Act, FIFRA, and TSCA can be treated using nanoparticles according to the invention and compositions including them. For example, agencies of the U.S. Government, such as the Department of Defense, are responsible for sites that can benefit from treatment with materials according to the invention, such as nanoparticles and compositions including them. Use of the materials according to the invention, for example, injection of nanoparticles into the ground, to treat water, wastewater, and contaminated soils can reduce risks to the public and environment.

For example, a method according to the present invention includes producing fluids containing metal nanoparticles (e.g., as a suspension) and/or polyphenols (or another compound derived from a fruit extract) (e.g., as a solution) for use in creating strongly reducing conditions either in situ (below ground) or in above ground waste treatment reactors to substantially destroy pollutants and/or contaminants susceptible to reduction processes. Examples of pollutants to which fluids containing metal nanoparticles and/or polyphenols can be applied to achieve remediation or mitigation of hazardous properties include liquid or particulate waste streams containing, for example, persulfate, peroxide, percarbonate, perborate, and/or perchlorate waste, energetic and/or oxidizing wastes from explosive and military applications, highly oxidized rocket fuel and propellants and breakdown products therefrom, chlorinated solvents, pesticides, and other compounds, polychlorinated biphenyls (PCBs), metals, such as chromium, heavy metals, such as mercury and lead, and metalloids, such as arsenic. For example, metal nanoparticles according to the present invention can be used to reduce perchlorate compounds from rocket fuel waste found at certain sites, for example, in the Colorado River.

In sites containing metal ions useful for forming nanoparticles, the fruit extract or a compound derived from the fruit extract can be injected into the ground to form metal nanoparticles in situ. The metal nanoparticles formed can then substantially destroy pollutants and/or contaminants, for example, those susceptible to reduction processes.

For example, green synthesized silver or composite silver nanometals according to the invention can be used to disinfect materials and disinfect biological agents. Such silver or composite silver nanometals can be, for example, incorporated into medical materials to provide disinfecting properties. Metal nanoparticles can have additional medical applications.

For example, nanoscale silver particles can be produced from a plant residue, such as concentrated particulate matter and/or pulp from a fruit, e.g. grape pomace. The silver nanoparticles can be incorporated into a bandage or wound dressing, and/or the silver nanoparticles can be incorporated together with a compound, such as a polyphenol, extracted from the plant residue into a bandage or wound dressing. The antibacterial properties of the silver nanoparticles and/or the compound, e.g., polyphenol, can be used to impart properties of infection inhibition and/or healing promotion to the bandage and/or wound dressing.

Nano-scale zero valent iron (nZVI) is of increasing interest for use in a variety of environmental remediation, water and waste water treatment applications. Initial ZVI research used microscale (˜150 μm) particles for environmental applications in reactive subsurface permeable barriers (PRBs) for chemical reduction of chlorinated solvents. In comparison to larger sized ZVI particles, nZVI has a greater reactivity due to a greater surface area to volume ratio. Recent environmental applications include removal of nitrite by ultrasound dispersed nZVI, dechlorination of dibenzo-P-dioxins, reduction of chlorinated ethanes, adsorption of humic acid and its effect on arsenic removal and hexavalent chromium removal. However, field applications of ZVI have been limited to granular particles used in permeable reactive barriers (PRB). While PRBs are found to be effective for the remediation of shallow aquifers, more cost-effective in situ technologies are needed for rapid and complete destruction of chlorinated contaminants in deep aquifers and in source zones. However, for this technology to be feasible, the nZVI particles must be small enough to be mobile in the targeted zones, and the transport behaviors (or size) of the nanoparticles in various soils must be controllable.

In many industrial applications, the faster the catalysis of peroxide and persulfate the better. However, the catalysis of peroxide and persulfate in subsurface remediation applications can be best conducted at a controlled rate and in many cases as slow as possible, while still maintaining effective catalysis. Slowing the catalysis rates using plant extract and plant extract-based surfactants can be effectively achieved and the desired rate can be obtained using bromothymol blue as a probe compound. Inclusion of plant extracts can reduce the rate of catalysis to, for example, 90%, 75%, 50%, 25%, 10%, 5%, 1% or less, compared to the rate without plant extract-containing catalysts. In terms of initial rate constants, the plant extract-controlled catalysts may decrease the initial rate constant to 0.2/min, 0.1/min, 0.05/min, 0.01/min, 0.005/min or otherwise as described for a particular application.

The metal ion concentration in solution can be within a range of, for example, from about 0.00001 M to 1.0 M, 0.0001 M to 1.0 M, 0.001 M to 1.0 M, or about 0.01 to 0.1 M, for example, up to or at least about 0.001 M, 0.005 M, 0.01 M, 0.05 M, 0.1 M, 0.2 M, 0.3 M, 0.4 M, 0.5 M, 0.6 M, 0.7 M, 0.8 M, 0.9 M, 1.0 M or more. For example, the metal ions in solution can have a concentration of about 10 mM. The plant extract can have a concentration of, for example, from about 5 g/L to about 200 g/L, or about 10 g/L to about 100 g/L, or about 15 g/L to about 50 g/L, or about 40 g/L to about 100 g/L, or up to or at least about 0.1, 0.5, 1, 5, 10, 15, 20, 30, 40, 50, 60, 70, 80, 90, 100, 110, 120, 130, 140, 150, 160, 170, 180, 190, 200 g/L or more. The metal nanoparticles can be present in a concentration of from about 0.0006 to about 0.6 M, about 0.005 to about 0.1 M, or up to or at least about 0.0001, 0.0005, 0.001, 0.005, 0.01, 0.05, 0.1, 0.2, 0.3, 0.4, 0.5, 0.6 M, 1 M or more (the concentration of the metal nanoparticles can refer either to the concentration of individual particles or the concentration of the metal atoms that make up the particles). The nanoparticles can have a diameter of, for example, from about 1 nm to about 1000 nm, from about 1 nm to about 300 nm, from about 5 nm to about 100 nm, from about 5 nm to about 50 nm, from about 10 to about 30 nm, from about 2 to about 20 nm, about 20 nm to about 85 nm, about 10 to about 50 nm, about 40 to about 100 nm, or up to or at least about 1 nm, 2 nm, 5 nm, 10 nm, 20 nm, 30 nm, 40 nm, 50 nm, 60 nm, 70 nm, 80 nm, 90 nm, 100 nm, 120 nm, 140 nm, 160 nm, 180 nm, 200 nm, 250 nm, 300 nm, 400 nm, 500 nm, 600 nm, 700 nm, 800 nm, 900 nm, 1000 nm or more.

For example, the dissolved metal ion can be provided by dissolving a metal salt in water. For example, the dissolved metal ion can be provided by dissolving a metal chelate in water. The metal nanoparticles can be formed at a rate of, for example, at least about 0.002 mol/L/min, at least about 0.01 mol/L/min, at least about 0.1 mol/L/min, at least about 0.5 mol/L/min or more, where “mol” refers to the moles of metal atoms that form the metal nanoparticles. For example, the providing of the dissolved metal ion, the providing of a plant extract, and/or the combining of the dissolved metal ion and the plant extract to produce one or more metal nanoparticles can be conducted at about room temperature and/or at about room pressure. For example, room temperature can be a temperature that is in a range that is comfortable for or can be tolerated by humans. For example, a temperature greater than or equal to about that of the freezing point of water and less than or equal to about the maximum temperature that naturally occurs on the earth's surface can be considered to be room temperature. For example, a temperature of greater than or equal to about 0° C., 4° C., 10° C., 15° C., 20° C., 25° C., 30° C., 35° C., 40° C., 45° C., and 50° C. and less than or equal to about 4° C., 10° C., 15° C., 20° C., 25° C., 30° C., 35° C., 40° C., 45° C., 50° C., and 60° C. can be considered to be room temperature.

For example, room pressure can be pressure that is greater than or equal to about the minimum that occurs on the earth's surface (including mountaintops) and less that or equal to about the maximum that occurs on the earth's surface (including below sea level depressions and the bottom of mines). For example, a pressure of greater than or equal to about 20 kPa, 30 kPa, 50 kPa, 70 kPa, 90 kPa, 95 kPa, 100 kPa, 101 kPa, 107 kPa, 120 kPa, 140 kPa, and less than or equal to about 30 kPa, 50 kPa, 70 kPa, 90 kPa, 95 kPa, 100 kPa, 101 kPa, 107 kPa, 120 kPa, 140 kPa, and 160 kPa can be considered to be room pressure.

The nanoparticles according to the present invention can have various shapes, including spheres, rods, prisms, hexagonal and mixed prisms, faceted shapes, wires, and other shapes.

In some embodiments, the amount of the plant extract used in the methods disclosed herein is sufficient to convert substantially all of the dissolved metal ion into nanoparticles. As used herein, “substantially all” encompasses, e.g., greater than 50%, or at least about 60%, 70%, 80%, 85%, 90%, 95% or more. Different meanings of “substantially all” may be apparent from the context.

The methods according to the present invention can be applied to the continuous synthesis of metal nanoparticles for large scale production. At the same time, the methods can be applied to utilizing industrial wastes with high biological and chemical oxygen demand, such as fruit waste, for example, pomace. The methods according to the present invention can be used to produce nanoparticles of a wide range of metals, including base metals, such as iron (Fe) and copper (Cu), as well as noble metals, such as gold (Au), platinum (Pt), silver (Ag), and palladium (Pd), and other metals such as indium (In) and manganese (Mn). The methods according to the present invention can be used in environmental remediation applications, for example, for the destruction of pollutants and chemicals of concern (COCs) and the decontamination of polluted sites.^{[18]}

### Example 1

### Synthesis of Metal Nanoparticles with Red Wine

Optimal reaction conditions for the formation of gold nanoparticles from red wine were determined by conducting UV-Visible and TEM studies following formation of the nanoparticles under a range of reaction conditions, that is, different ratios of metal salt to wine, different microwave powers, and different times of exposure to microwave radiation.

From the UV-Visible spectra and TEM micrographs it was seen that gold nanoparticles were optimally formed when 2 mL of 10 mmol/L solution of HAuCl₄ (procured from Aldrich chemicals and used as received) was used with 5 mL of red wine and exposed to microwave irradiation at a power of 50 watts for a reaction time of 1 minute (60 seconds). The reaction was conducted in a 10 mL crimp sealed thick walled glass tube equipped with a pressure sensor and magnetic bar. The microwave irradiation was conducted inside the cavity of a CEM Discover focused MW synthesis system. The red wine (Gato Negro, Chile) was procured from local grocery shops and was filtered through 0.45 micron filter before use.

Formation of the particles were observed as a change of color of the reaction mixture. The solution turned reddish brown at the end of the reaction. After completion of the reaction, the tube was cooled to room temperature, particles centrifuged, and dispersed in water. These nanoparticles were then used for further characterizations.

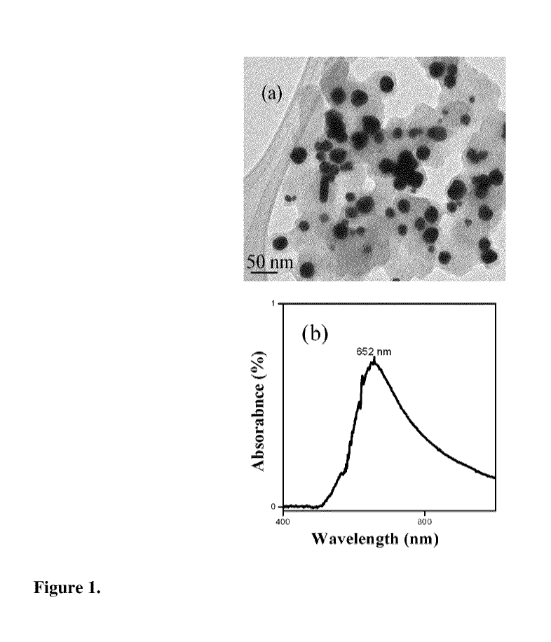

FIG. 1 (a, b) shows the transmission electron microscope (TEM) micrograph and UV-Visible spectrum of the Au nanoparticles produced. The UV-Visible spectrum shows the plasmon peak at 652 nm and the TEM micrographs show that the dispersed (non-aggregated) particles have a size in the range of from about 10 to about 30 nm. Most of the particles were spherical in shape, although a few rod shaped particles were also observed in the TEM micrographs. TEM micrographs were recorded on a Phillips CM 20 TEM microscope at an operating voltage of 200 kV. A drop of the as-synthesized nanoparticles in ethanol was loaded on a carbon coated copper grid and then allowed to dry at room temperature before recording the micrographs. The UV spectra were recorded on a Hewlett Packard 845×UV-Visible instrument.

### Example 2

### Synthesis of Gold Nanoparticles with White Wine

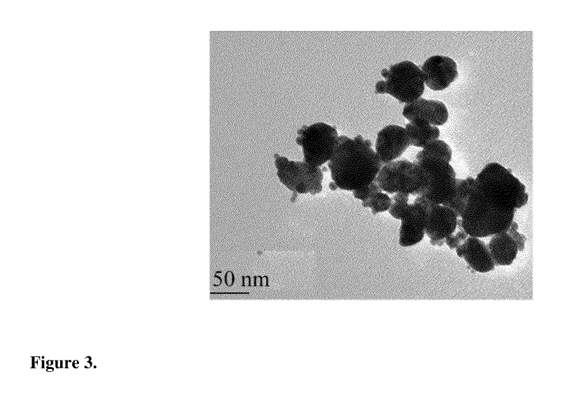

Nanoparticles were synthesized under the same reaction conditions as presented in Example 1, except that white wine was used instead of red wine. The white wine (Gato Negro, Chile) was procured from local grocery shops and was filtered through 0.45 micron filter before use. The nanoparticles produced were found to be bigger in size than those produced with the red wine and were found to be agglomerated, in contrast with the nanoparticles produced with red wine. A TEM micrograph showed the particles to be in the range of from about 40 nm to about 50 nm (see FIG. 3). It is understood that agglomerated particles were formed when white wine was used, because white wine has lesser amounts of polyphenolic compounds, which can act as the capping agent during the synthesis procedure, than does red wine.

### Example 3

### Synthesis of Gold Nanoparticles with Grape Pomace

Red grape pomace, a waste product from the manufacture of wine, has higher amounts of polyphenolics than does wine itself, a high value product. Frozen red grape pomace used in the experiment was received from a wine company, E. J. Gallo, California, USA. 100 g of the as received pomace was soaked in 200 mL water for one-half hour and then filtered through a sieve to clear out the big solid particles. The wine colored water was then used for the nanoparticle synthesis.

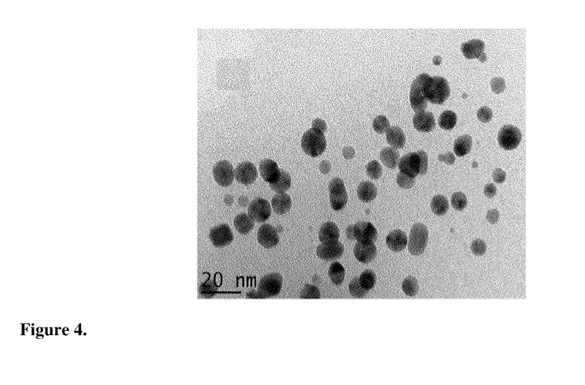

The same optimized conditions for generating nanoparticles using red wine, as presented in Example 1, were used with pomace. Highly dispersed particles of gold (Au) with a narrow size distribution were produced with a yield of more than 80%. The yields can vary from 80% to 90% depending on the efficiency of centrifugation and washing processes, if required. The gold nanoparticles had a size range of from about 5 nm to about 10 nm and had spherical morphology (see FIG. 4).

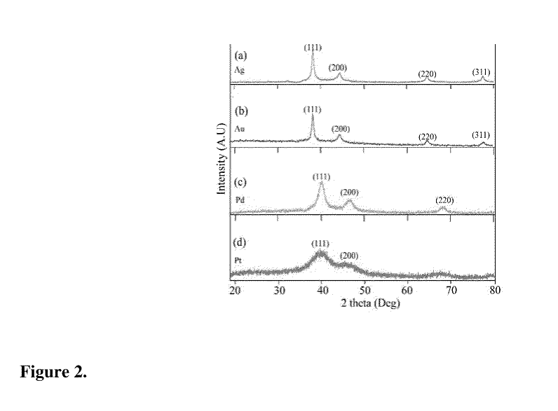

An X-ray diffraction pattern of the as-synthesized particles (see FIG. 2(b)) confirmed the formation of gold with crystallite size 12.5 nm, which was comparable to the particle size determined from TEM micrographs. The phase of the as-synthesized nanoparticles was determined by X-ray diffraction in an MMS X-ray diffractometer with a Cu K-alpha source in the 2-theta range 10 to 80. The data were collected with a step of 1 deg/min. A few drops of the as-synthesized nanoparticles were added to a quartz plate and dried at room temperature before recording the X-ray pattern.

### Example 4

### Synthesis of Gold Nanoparticles with Grape Pomace or Red Wine at Room Temperature

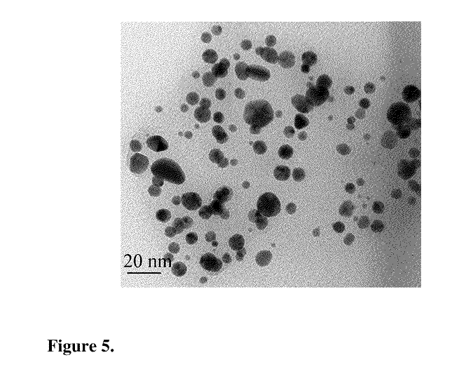

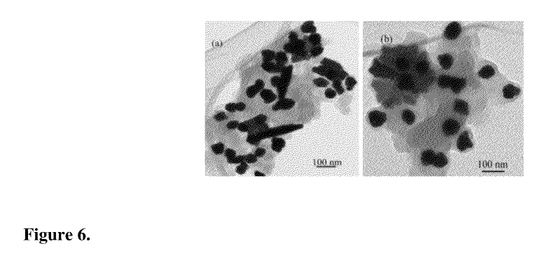

Pomace was used to produce crystalline gold nanoparticles within ½ hour at room temperature (FIG. 5). The same experiment repeated using red wine produced nanoparticles without any specific morphology. The nanoparticle size did not change when the reaction time was extended to 48 h. FIG. 6 (a, b) presents the TEM images of the gold nanoparticles synthesized at room temperature after 3 hours and 48 hours using red wine.

### Example 5

### Synthesis of Silver, Palladium, and Platinum Nanoparticles with Grape Pomace

The optimized reaction conditions (50 watt power, 60 seconds reaction time, 2 mL of 10 mmol/L solution, 5 mL pomace extract) described in Example 1 (using grape pomace instead of red wine and silver, palladium, and platinum salts instead of gold salt) were used for the synthesis of silver (Ag), palladium (Pd), and platinum (Pt) nanoparticles. The metal ion solutions were formed from AgNO₃, Na₂PdCl₄, and HPtCl₄, procured from Aldrich chemicals and used as received.

Formation of the particles were observed as a change of color of the reaction mixture. The solution turned reddish brown at the end of the reaction. After completion of the reaction, the tube was cooled to room temperature, particles centrifuged, and dispersed in water.

The silver (Ag) nanoparticles formed were highly crystalline with a size of about 10 nm. The palladium (Pd) and platinum (Pt) nanoparticles formed were smaller in size: the palladium (Pd) particles had a size of from about 5 nm to about 10 nm; the platinum (Pt) nanoparticles had a size of from about 3 nm to about 4 nm.

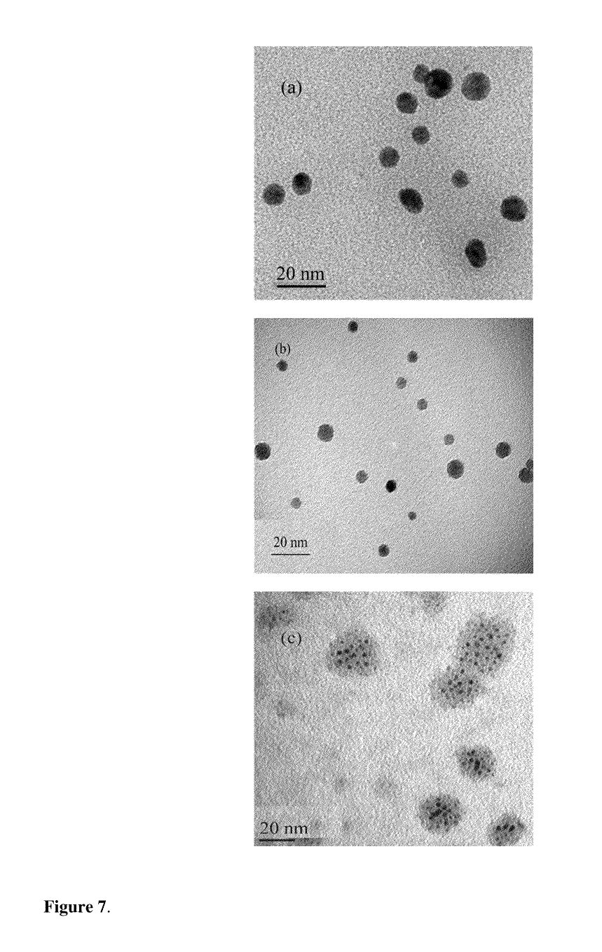

FIG. 7 (a-c) presents TEM micrographs of the as-synthesized nanoparticles of silver (Ag), palladium (Pd), and platinum (Pt) respectively. X-ray diffraction patterns confirm the formation of the metal nanoparticles without impurities. The crystallite sizes calculated using the Scherer formula from FWHM of the highest intensity diffraction peaks are 19.16 nm, 4.27 nm, and 1.5 nm for silver (Ag), palladium (Pd), and platinum (Pt) respectively. These are comparable to the particle sizes determined from the TEM micrographs. FIG. 2 (a,c,d) shows the X-ray diffraction patterns for the as-synthesized nanoparticles. Except for gold nanoparticles, nanoparticles formed at room temperature tended to be amorphous.

### Example 6

### Production of Iron Nanoparticles

Grape pomace or red wine is used to form iron nanoparticles from iron salts. For example, ferric chloride (FeCl₃) is combined with (for example, dissolved in) red wine or an aqueous extract of grape pomace. The mixture or solution is allowed to react at room temperature. Alternatively, the mixture of solution is heated, for example, by exposure to microwave radiation. Following reaction, the iron nanoparticles formed are concentrated or isolated, for example, using a technique such as centrifugation, reverse osmosis, and/or evaporation. The concentrated or isolated nanoparticles are redispersed, for example, in water. In an alternative embodiment, a fruit extract other than grape pomace or red wine is used. In an alternative embodiment, an iron salt other than ferric chloride, for example, ferric nitrate (Fe(NO and/or ferrous sulfate (FeSO₄) is used.

### Example 7

### Production of Bimetallic and Multimetallic Nanoparticles

Bimetallic and multimetallic nanoparticles can be produced with a method similar to that presented in Example 1. However, instead of one metal salt, two or more metal salts can be simultaneously combined with the fruit extract, e.g., red wine or red grape pomace. Alternatively, a first metal salt can be combined with the fruit extract, the reaction allowed to proceed for a period of time (either with or without heating) and then a second metal salt can be added and the reaction allowed to proceed further. For example, the latter approach can be used to produce “core-shell” or “onion-layered” bi- or multimetallic nanoparticles. For example, the first dissolved metal ion can be added to a vessel first and the second dissolved metal ion can be added after a period of time, for example, of at least about 1 second, 10 seconds, 15 seconds, 30 seconds, or 60 seconds, for example, a period of time in the range of from about 15 to about 30 seconds or from about 30 seconds to about 60 seconds, which generally leads to nanoparticles in which the first metal is present primarily in the core of the metal nanoparticle and the second metal is present primarily in an outer layer around the core of the metal nanoparticle. The first metal can be, for example, iron and the second metal can be, for example, palladium. Alternatively, palladium can be the first metal and iron can be the second metal. As used herein, “simultaneously” encompasses events that happen at precisely the same time as well as events that happen somewhat asynchronously, provided they are close enough in time to substantially accomplish the ends of the procedures requiring more or less simultaneous events. For example, in a procedure for preparing bimetallic nanoparticles in which it is desired that the metals be interspersed throughout the particle, introduction of the two metal ions will be considered “simultaneous” if, for example, the procedure produces, or is capable of producing, bimetallic nanoparticles with the metals substantially interspersed throughout the particles.

### Example 8

### DPPH Test for Determination of Gross Antioxidant Capacity of Fruit Extract

A 2,2-diphenyl-1-picrylhydrazyl (DPPH) test can be used to measure the gross antioxidant capacity of plant extracts, for example, fruit extracts. DPPH (2,2-diphenyl-1-picrylhydrazyl) is a stable free radical in an aqueous solution. When a fruit extract in solution is exposed to DPPH, the amount of DPPH decreases according to the antioxidant capacity of the fruit extract. Generally, the more DPPH consumption, the greater concentration of plant or fruit extract components, e.g., polyphenols. The more plant or fruit extract components, e.g., polyphenols, are in solution, the greater their capacity to make nanometal particles. A DPPH test can be used to determine which plant or fruit extracts, and under what extraction conditions, yield the highest concentration of plant or fruit extract components, e.g., polyphenols for use in making nanometal particles.

A DPPH stable radical method for analysis of radical scavenging properties related to antioxidant activity can be used to screen plant or fruit extract for potential use in the manufacture of zero valent nanoparticles. This method can be used to determine and optimize the amount of ferric iron added to a given plant or fruit extract for the formation of zero valent iron nanoparticles. One optimization goal in the manufacture of nanometal particles using plant or fruit extracts is to determine how much ferric iron (or other metal) can be added to a given plant or fruit extract to ensure complete conversion of ferric iron to zero valent iron. This DPPH screening method can be used with metals other than iron, such as noble metals, and with plant extracts such as green tea or fruit extracts, such as pomace, for the manufacture of nanometals using plant or fruit extracts.

Experimental conditions are presented in Table 1.

TABLE 1
DPPH Stable Radical Consumption by Plant Extracts Before and After Reaction
with Ferric Chloride to Manufacture Nanoscale Zero Valent Iron Particles

| | | Absorbance of | | |
|---|---|---|---|---|
| | | Treated Samples | | Test |
| Test | Reaction Matrix | at 517 nm | Observations | Conc, g/L |
| 1 | L mL DI Water + 3 mL EtOH + 1 mL | 0.955 | Purple | |
| | DPPH Soln | | | |
| 2 | 1 mL 200x, 2.5 g/L Tea Extract + 3 mL | 0.836 | Purple | 2.5 |
| | EOH4 + 1 mL DPPH Soln | | | |
| 3 | 1 mL 200x, 5 g/L Tea Extract + 3 mL | 0.793 | Purple | 5 |
| | EOH4 + 1 mL DPPH Soln | | | |
| 4 | 1 mL 200x, 10 g/L Tea Extract + 3 mL | 0.637 | Purple | 10 |
| | EOH4 + 1 mL DPPH Soln | | | |
| 5 | I mL 200x, 20 gfL Tea Extmct + 3 mL | 0.593 | Light Purple | 20 |
| | EOH4 + 1 mL DPPH Soln | | | |
| 6 | 1 mL 200x, 40 g/L Tea Extract + 3 mL | 0.072 | Tea | 40 |
| | EOH4 + 1 mL DPPH Soln | | | |
| 7 | 1 mL 200x, 2.5 g/L Tea Extract/NZV1 + | 0.86 | Purple | 2.5 |
| | 3 mL EtOH4 + 1 mL DPPH Soln | | | |
| 8 | 1 mL 200x, 5 g/L Tea Extract/NZVI + | 0.858 | Purple | 5 |
| | 3 mL EtOH4 + 1 mL DPPH Soln | | | |
| 9 | 1 mL 200x, 10 g/L Tea Extract/NZVI + | 0.802 | Purple | 10 |
| | 3 mL EtOH4 + 1 mL DPPH Soln | | | |
| 10 | 1 mL 200x, 20 g/L Tea Extract/NZVI + | 0.774 | Purple | 20 |
| | 3 mL EtOH4 + 1 mL DPPH Soln | | | |
| 11 | 1 mL 200x, 40 g/L Tea Exttact/NZVI + | 0.527 | Purple pink | 40 |
| | 3 mL EtOH4 + 1 mL DPPH Soln | | | |

Experimental Procedure:

1) DPPH (500 uM) was dissolved in pure ethanol (96%). The radical stock solution was prepared fresh daily.
2) The DPPH solution (1 mL) was added to 1 mL of sample extract with 3 mL of ethanol.
3) The mixture was shaken vigorously for 10 min and allowed to stand at room temperature in the dark for another 20 min
4) A decrease in absorbance of the resulting solution (the result of consumption of the radical scavenger) was measured at 517 nm.

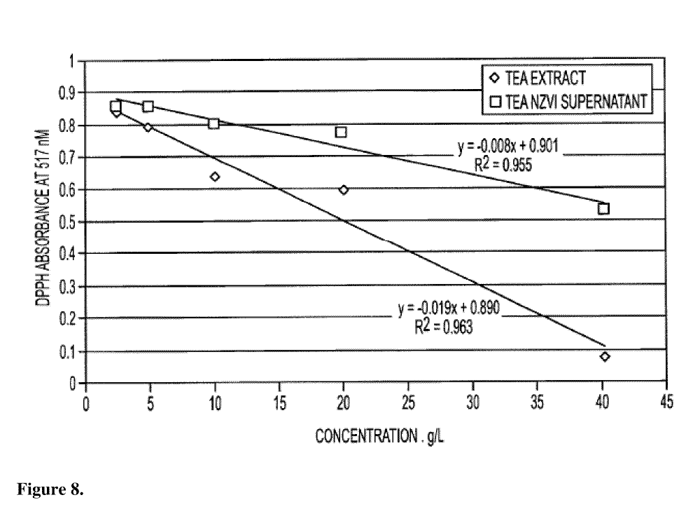

Tests 1 though 5 in Table 1 were used to determine the effects of increasing concentrations of dry green tea used to make tea extract in heated water on the spectroscopic absorbance of the DPPH radical. The results of tests 1 through 5 are represented by the lower line of best fit in FIG. 8, demonstrating a linear relationship between dry green tea concentration (used to make the tea extract) and DPPH absorbance at 517 nm. The green tea extract was diluted by a factor of 200 to obtain usable absorbance measurements in a linear range. The same green tea extracts used in tests 1 through 5 were then added to ferric chloride to make zero valent iron nanoparticles. A ratio of 2:1 (v/v) of 0.1 M FeCl₃ to tea extract was used to make the zero valent iron nanoparticles used in tests 7 through 11. The DPPH absorbance of the solution following the formation of nZVI particles was considerably higher than with the original green tea extracts alone, reflecting that some of the compounds in the tea extract responsible for consumption of the DPPH free radical were consumed in the formation of the nZVI particles. This is evident by examination of the upper line of best fit in FIG. 8. The difference between the two lines represents the net consumption of DPPH free radical absorbance when nanometal particles are manufactured. Polyphenolic compounds and other compounds in the tea extract were consumed during the production of metal nanoparticles, as evidenced by the difference between the two lines. The net consumption can be used to run successive dosing tests for the concentration ratio of the metal salt solutions and the plant extract, thereby enabling a relationship to be derived between DDPH absorption and metal salt added. This relationship can be used to establish the optimum dose of plant or fruit extract and metal salt solution to use the plant or fruit extract to the maximum extent in the formation of metal nanoparticles. This method can be applied to plant extracts, such as green tea, and/or fruit extracts, such as pomace, and can be applied to nanoparticles other than nano-zero valent iron, for example, to nanoparticles of other base metals, such as copper, and to nanoparticles of noble metals, such as gold, silver, palladium, and platinum.

### Example 9

### Application of Metal Nanoparticles Synthesized with Fruit Extracts to Environmental Remediation

Metal nanoparticles synthesized with fruit extract can be used to promote the degradation of pollutants and contaminants, such as organic compounds. For example, a method according to the invention can include injecting the metal nanoparticles into the ground to treat a contaminated soil. Alternatively, the metal nanoparticles can be formed in situ in a medium, for example, in soil. A fruit extract or a component of a fruit extract can be introduced into a contaminated medium, for example, injected into contaminated soil. The fruit extract or component thereof can react with metal ions naturally present in the medium or soil or introduced (for example, injected) into the medium or soil to form metal nanoparticles. The metal nanoparticles can then promote degradation of the contaminant or the pollutant, for example, by reducing the contaminant or stimulating biological reduction of the contaminant to reduce its concentration. A chelating agent, such as EDTA, citric acid, and/or EDDS can be introduced or injected into the medium or soil.

The documents cited herein are hereby incorporated by reference in their entirety. U.S. Patent Application Nos. 60/960,340, filed Sep. 26, 2007, Ser. No. 12/680,103, filed Mar. 25, 2010, 61/071,785, filed May 16, 2008, Ser. No. 12/667,384, filed Apr. 13, 2010, and 61/246,953, filed Sep. 29, 2009, and International Patent Application Numbers PCT/US2008/011235, filed Sep. 26, 2008 and PCT/US2009/044402, filed May 18, 2009 are hereby incorporated by reference in their entirety.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

### REFERENCES

[1] P. Alivisatos, Science 1996, 271, 933-937.
[2] S. Kundu, H. Liang, Adv. Mater. 2008, 20, 826-831.
[3] M. Mandal, S. Kundu, T. K. Sau, S. M. Yusuf, T. Pal, Chem. Mater. 2003, 15, 3710-3715.
[4] S. H. Joo, J. Y. Park, C. K. Tsung, Y. Yamada, P. Yang, G. A. Somorjai, Nature Mater. 2009, 8, 126-131.
[5] P. Raveendran, J. Fu, S. L. Wallen, J. Am. Chem. Soc. 2003, 125, 13940-13941.
[6] S. S. Shankar, A. Rai, A. Ahmad, M. Shastry, J. Colloid Interface Sci. 2004, 275, 496-502.
[7] S. Kundu, M. Mandal, S. K. Ghosh, T. Pal, J. Colloid Interface Sci. 2004, 272, 134-144.
[8] J. L. Marignier, J. Belloni, M. O. Delcourt, J. P. Chevalier, Nature 1985, 317, 344-345.
[9] B. Hu, S-B. Wang, K. Wang, M. Zhang, S-H. Yu, J. Phys. Chem. C 2008, 112, 11169-11174.
[10] P. Mukherjee, A. Ahmad, D. Mandal, S. Senapati, S. R. Sainkar, M. I. Khan, R. Parishcha, P. V. Ajaykumar, M. Alam, R. Kumar, M. Sastry, Nano Lett. 2001, 1, 515-519.
[11] A. Panacek, L. Kvitek, R. Prucek, M. Kolar, R. Vecerova, N. Pizurova, V. K. Sharma, T. Nevecna and R. Zboril, J. Phys. Chem. B 2006, 110, 16248-16253.
[12] M. N. Nadagouda, R. S. Varma, Cryst. Growth Des. 2007, 7, 2582-2587.
[13] M. N. Nadagouda, R. S. Varma, Cryst. Growth Des. 2007, 7, 686-690.
[14] B. Baruwati, V. Polshettiwar, R. S. Varma, Green Chem. 2009, 11, 926-930.
[15] V. Polshettiwar, B. Baruwati, R. S. Varma, ACS Nano 2009, 3, 728-736.
[16] B. Baruwati, M. N. Nadagouda, R. S. Varma, J. Phy. Chem. C 2008, 112, 18399-18404.
[17] M. N. Nadagouda, R. S. Varma, Green Chem. 2008, 10, 859-862.
[18] G. E. Hoag, J. B. Collins, J. L. Holcomb, J. R. Hoag, M. N. Nadagouda, R. S. Varma, J. Mater. Chem., 2009, DOI: 10.1039/b909148c.

We claim:

1. A method for making one or more metal nanoparticles, comprising:
providing a metal ion;
providing a fruit extract that comprises a compound selected from the group consisting of a reducing agent, a capping agent, a stabilizing agent, a solvent, a vitamin, a sugar, a peptide, a polyphenol, an alcohol, an anthocyanin, and combinations; and
combining the metal ion and the fruit extract to produce metal nanoparticles,
wherein if the fruit extract is from a citrus fruit, the fruit extract comprises a compound selected from the group consisting of a reducing agent, a capping agent, a peptide, a polyphenol, an alcohol, an anthocyanin, and combinations.

2. The method of claim 1,
wherein the metal ion is in solution and
wherein the fruit extract comprises a compound selected from the group consisting of a reducing agent, a capping agent, a peptide, a polyphenol, an alcohol, an anthocyanin, and combinations.

3. The method of claim 2, wherein the fruit extract comprises a polyphenol and/or an anthocyanin.

4. The method of claim 2, wherein the metal ion solution and the fruit extract are combined at room temperature to produce the metal nanoparticles.

5. The method of claim 2, further comprising heating the metal ion solution and the fruit extract with microwave radiation.

6. The method of claim 2, wherein the fruit extract comprises a solvent, a reducing agent, and a stabilizing and/or a capping agent and/or a polyphenolic.

7. The method of claim 2, wherein the fruit extract is selected from the group consisting of red grape pomace and red wine.

8. The method of claim 2, wherein the metal ion is selected from the group consisting of gold (Au), platinum (Pt), silver (Ag), and palladium (Pd).

9. The method of claim 2, wherein the metal ion is selected from the group consisting of copper (Cu), iron (Fe), indium (In), and manganese (Mn).

10. The method of claim 2, wherein the metal ion comprises iron (Fe).

11. The method of claim 2, wherein the concentration of the metal ion in the solution is in the range of from about 0.1 mM to about 1000 mM.

12. The method of claim 2, wherein the concentration of the metal ion in the solution is about 10 mM.

13. The method of claim 2, further comprising administering the metal nanoparticles to a pollutant to substantially destroy the pollutant.

14. The method of claim 2, further comprising injecting the metal nanoparticles into the ground to treat a contaminated soil.

15. A composition comprising one or more nanoparticles prepared according to the method of claim 2, wherein the one or more metal nanoparticles have a mean diameter in the range of from about 2 to about 20 nm.

16. A composition comprising one or more nanoparticles prepared according to the method of claim 2, wherein the one or more metal nanoparticles are substantially non-aggregated.

17. The method of claim 1,
wherein the metal ion is in solution and
wherein the fruit extract is a non-citrus fruit extract that comprises a compound selected from the group consisting of a reducing agent, a capping agent, a stabilizing agent, a solvent, a vitamin, a sugar, a peptide, a polyphenol, an alcohol, an anthocyanin, and combinations.

18. A particle, comprising:
an iron nanoparticle having a surface; and
a compound selected from the group consisting of an amino acid, a peptide, an anthocyanin, a polyphenol, a phenolic compound, gallic acid, a catechin, a quercetin, tartaric acid, malic acid, succinic acid, resveratrol, and combinations,
wherein the compound is coated on the surface of the iron nanoparticle.

19. The method of claim 1, comprising:
introducing the fruit extract into a medium, wherein the medium comprises the metal ion;
allowing the compound(s) of the fruit extract to react with the metal ion in the medium to form the one or more metal nanoparticles; and
allowing the one or more metal nanoparticles to reduce or stimulate biological reduction of a contaminant in the medium to reduce the concentration of the contaminant.

20. The method of claim 19, wherein the medium comprises a soil and wherein introducing the fruit extract into the medium comprises injecting the fruit extract into the soil.
